(19) United States
(12) Patent Application Publication
(10) Pub. No.: US 2013/0335317 A1
(43) Pub. Date: Dec. 19, 2013

(54) APPARATUSES FOR CONTRIBUTIVELY MODIFYING IMAGE ORIENTATION FOR DISPLAY

(71) Applicant: Silicon Motion, Inc., Jhubei City (TW)

(72) Inventors: Jin-Yun LIU, Shanghai (CN); Bin CHEN, Shanghai (CN)

(21) Appl. No.: 13/912,968

(22) Filed: Jun. 7, 2013

(30) Foreign Application Priority Data
Jun. 19, 2012 (CN) 201210203146.7

(51) Int. Cl. G06T 3/60; G06F 3/01

(52) U.S. Cl. CPC G06T 3/60; G06F 3/01
USPC 345/156

(57) ABSTRACT

An embodiment of an apparatus for contributively modifying an image orientation is introduced. The apparatus includes a display angle detection unit configured to detect a display angle setting. A parameter storage unit stores a display parameter being utilized to determine how to modify images. The hot-plugging processing unit changes a hot-plugging signal to cause the external apparatus to recognize that the display processing unit is disconnected therefrom, and modifies the content of the display parameter with a new display parameter value that is consistent with the current display placement when the display angle setting satisfies a display angle refreshing condition. The hot-plugging processing unit changes the hot-plugging signal to cause the external apparatus to recognize that a new apparatus is connecting, thereby enabling the external apparatus to read out the new display parameter value and generate the image stream corresponding to the new display parameter value.

### CROSS REFERENCE TO RELATED APPLICATIONS

This application claims priority of China Patent Application No. 201210203146.7, filed on Jun. 19, 2012, the entirety of which is incorporated by reference herein.

### BACKGROUND

1. Technical Field

The present invention relates to image generation and display apparatuses, and in particular to apparatuses for contributively and dynamically modifying image orientation for display in response to a new display placement.

2. Description of the Related Art

Most electronic devices today employ displays. Sometimes, for the purpose of easy portability, the displays are made to be small, and they are installed in portable electronic devices such as netbooks, which are mainly used to surf the Internet, tablet PCs (personal computers) or mobile phones. Nowadays, the processing capability of portable electronic devices is greatly improved, thus they can provide high-resolution images to be displayed on an external display via an output interface.

The external display may be any LCD (liquid crystal display) monitor, as well as televisions, projectors, and the like. A typical interface being utilized to connect to the external display may be any DVI (digital visual interface), HDMI (High-Definition Multimedia Interface), Thunderbolt, and the like. Another typical way to connect thereto is to provide an external video adaptor, in which one end connects to the portable electronic device and the other end connects to the external display, such that the images received from the portable electronic device are further processed and output to the external display.

Although the external display quality is widely accepted by users and the price of external displays is affordable, the passively displayed images do not fulfill users' requirements if they require further adjustment, such that the external display cannot be widely used with portable electronic devices.

Thus, apparatuses with the capability of dynamically modifying images for display are needed.

### BRIEF SUMMARY

An embodiment of an apparatus for contributively modifying an image orientation is introduced. A display processing unit thereof receives an image stream from an external apparatus through a transmission interface and generates an image accordingly.

The apparatus includes at least a display angle detection unit and a hot-plugging processing unit. The display angle detection unit is configured to detect the display angle setting. The hot-plugging processing unit is configured to connect to the display angle detection unit and a parameter storage unit. The parameter storage unit stores a display parameter being utilized to determine how to modify images.

The external apparatus reads out the display parameter and provides the image stream corresponding to the display parameter. The hot-plugging processing unit changes a hot-plugging signal to cause the external apparatus to recognize that the display processing unit has disconnected therefrom when the display angle setting satisfies a display angle refreshing condition.

The hot-plugging processing unit modifies the content of the display parameter with a new display parameter value that is consistent with the current display placement. After the aforementioned display parameter modification, the hot-plugging processing unit changes the hot-plugging signal to cause the external apparatus to recognize that a new apparatus is connecting, thereby enabling the external apparatus to read out the new display parameter value and generate the image stream corresponding to the new display parameter value.

Another embodiment of an apparatus for connecting to a display processing unit through a transmission interface and providing an image stream to the display processing unit is introduced. The display processing unit generates a display image according to the image stream.

The apparatus includes at least a hot-plugging detection unit, a display angle reading unit and an image generation unit. The hot-plugging detection unit is configured to detect a hot-plugging signal to determine whether the display processing unit has connected thereto.

The display angle reading unit is configured to connect to the hot-plugging detection unit and read out a display parameter from the display processing unit when detecting that the display processing unit has connected thereto. The display parameter may be a reserved field of a video transmission interface standard indicating the orientation of the display image.

The image generation unit is configured to connect to the display angle reading unit and generate the image stream according to the read-out display parameter.

Still another embodiment of an apparatus for contributively modifying an image orientation is introduced. The display processing unit thereof receives an image stream from an external apparatus through a transmission interface and accordingly generates an image.

The apparatus includes at least a display angle detection unit, a display angle processing unit and a transmitter. The display angle detection unit is configured to detect the display angle setting. The display angle processing unit is configured to connect to the display angle detection unit to read out the display angle setting. The transmitter is configured to connect to the display angle processing unit and transmit the display angle setting to the external apparatus.

The external apparatus modifies the image stream when detecting that the display angle setting has been renewed, causing the display processing unit to be capable of displaying the display image that corresponds to the renewed display angle setting.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system architecture of an embodiment of the invention;

FIG. 2 is a schematic diagram of feasible hardware architecture of the computer 104 as shown in FIG. 1;

FIG. 3 illustrates an embodiment of the feasible software architecture of the computer 104 as shown in FIG. 2;

FIG. 4 illustrates exemplary hardware configurations of the external adaptor 108 as shown in FIG. 1;

FIG. 5 illustrates exemplary implementations of the external display 102 as shown in FIG. 1;

FIGS. 6A and 6B illustrate a schematic diagram of DVI (digital visual interface) transmission interface pins;

FIG. 7 is a flowchart of an exemplary system operation according to the invention;

FIGS. 8A to 8D illustrate changes of the displayed image when the user rotates a display at different times according to an embodiment of the invention;

FIG. 9A illustrates a rotated image undergoing reshaping;

FIG. 9B illustrates a rotated image undergoing cutting;

FIGS. 10A to 10C illustrate an embodiment applied to a projector 166; and

FIG. 11 illustrates another exemplary implementation of the external display.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the invention.

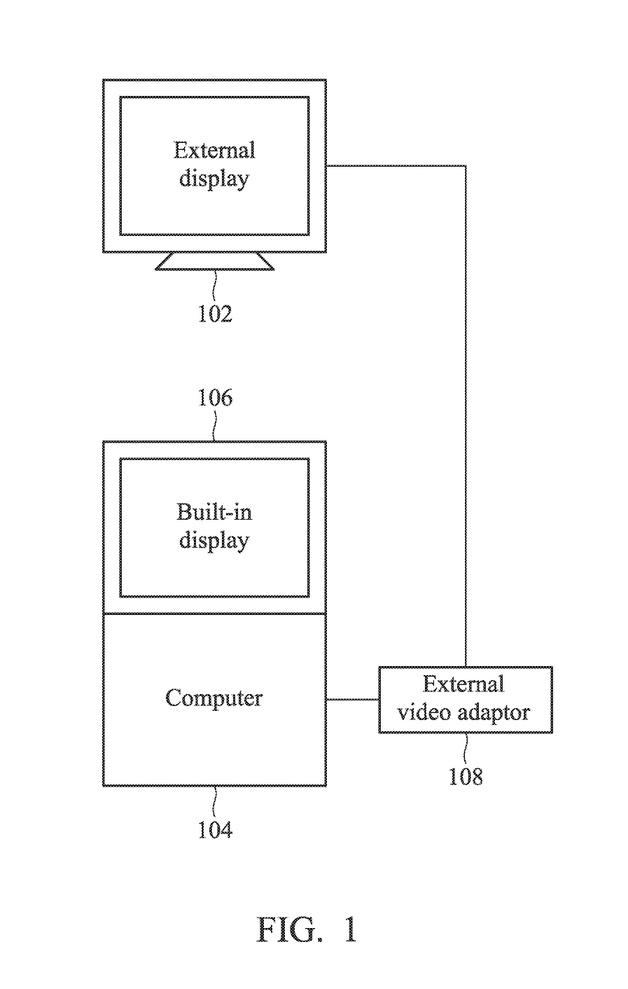

Referring to FIG. 1, the system architecture of an embodiment of the invention is illustrated. The computer 104 comprises a built-in display 106, and couples or connects to an external display 102 via an external video adaptor 108. In the embodiment, the external video adaptor 108 couples or connects to the computer 104 via a USB (universal serial bus) interface, and couples or connects to the external display 102 via a DVI (digital visual interface) interface. It will be understood that, when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

In the embodiment, the computer 104 may be a typical notebook computer. While the embodiment is described herein with respect to a notebook computer, it should be apparent that the disclosed implementations can be incorporated in, or integrated with, any electronic device that is capable of computing, including but not limited to a desktop computer, a multimedia player, a tablet PC, a mobile phone, etc.

In the embodiment as shown in FIG. 1, the computer 104 is equipped with a built-in display 106. Although the computer has been described having specific features, such as the built-in display, it should be apparent that the disclosed implementations may not necessarily provide it. For example, an optical disk player or a set-top box may only utilize the external display 102 as a main display.

In the embodiment as shown in FIG. 1, the external video adaptor 108 is located outside of and connects to the computer 104. Alternatively, in some implementations, those skilled in the art may install the video adaptor 108 inside the computer 104 as its entirety. In some other implementations, those skilled in the art may install the video adaptor 108 in the external display 102 as its entirety.

In the embodiment as shown in FIG. 1, the external display 102 has a display panel. While the embodiment is described herein with respect to a display having a display panel, it should be apparent that the disclosed implementations can be incorporated in, or integrated with, any electronic device that is capable of video processing, including but not limited to a projector or a video recorder capable of receiving image data and recording video or image streams, etc.

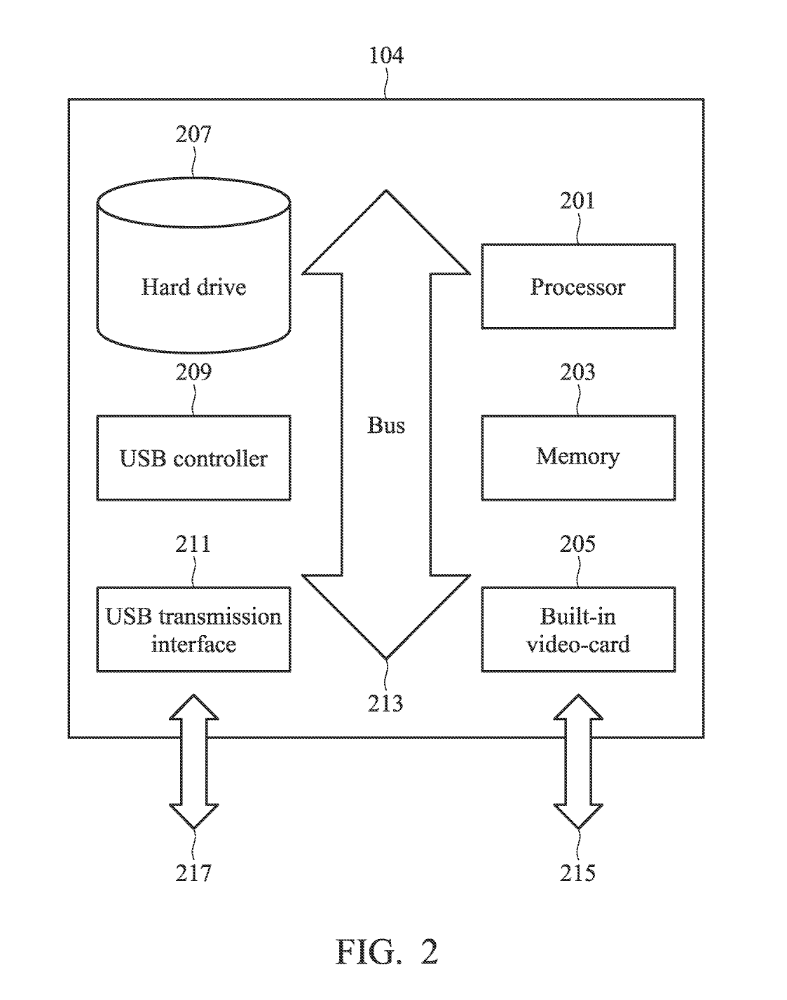

Please refer to FIG. 2, a schematic diagram of feasible hardware architecture of the computer 104 as shown in FIG. 1.

In the exemplary FIG. 2, the computer 104 comprises a processor 201, a memory 203, a built-in video-card 205, a hard drive 207, a USB controller 209, and a USB transmission interface 211. The processor 201 loads program code from the hard drive 207 into the memory 203 and executes a wide range of computing operations as required.

Typically, a portion of the computing operations comprise generating image data to be transmitted to the built-in video-card 205 via a bus 213. The built-in video-card 205 processes the image data to generate and transmit a corresponding image or video stream 215 to the built-in display 106 as shown in FIG. 1.

The processor 201 may determine if the external video adaptor 108 as shown in FIG. 1 has been coupled or connected to the USB controller 209 through the USB transmission interface 211. If so, the processor 201 generates the required image data in light of the read-out program code. The image data is transmitted to the USB transmission interface 211 via the bus 213 and is further transmitted to the external video adaptor 108 as shown in FIG. 1. The external video adaptor 108 processes the received image data, transforms the processed one into corresponding image streams, and further transmits the transformed one to the external display 102 for display.

While modules 201 to 217 are described in the computer 104, as shown in FIG. 2, it should be apparent that any of the modules 201 to 217 can be removed or replaced with another element based on different implementation requirements without departing from the spirit of the present invention. For example, it should be appreciated that, instead of the USB transmission interface 211, the peripheral interface may be a thunderbolt interface, a commonly used AV interface, a proprietary interface, etc. As mentioned above, while the embodiment is described herein with respect to the computer 104, it should be apparent that the disclosed implementations can be incorporated in, or integrated with, any electronic device that is capable of computing, including a mobile phone. If a mobile phone, all or a portion of the modules illustrated in FIG. 2 may be incorporated in an IC (integrated circuit) chip.

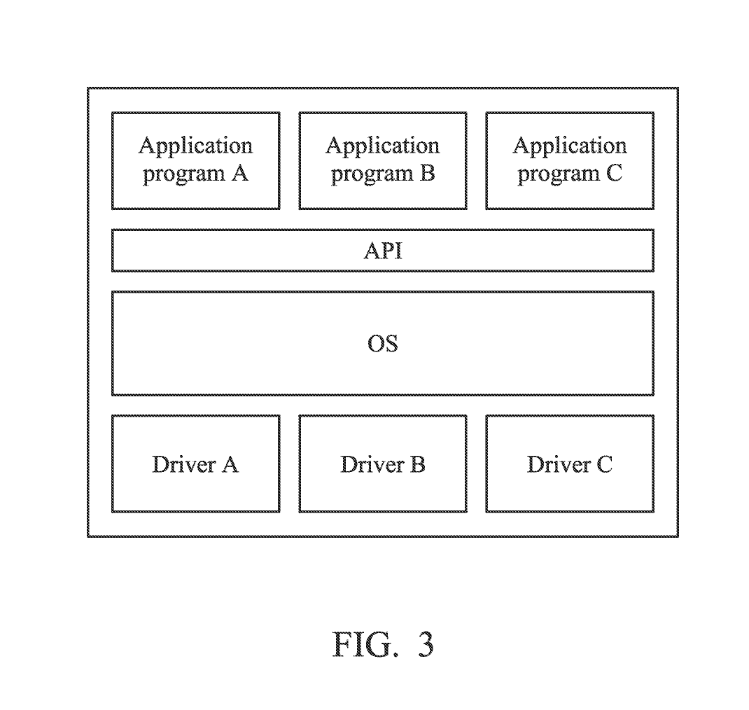

Please refer to FIG. 3, which illustrates an embodiment of feasible software architecture for the computer 104 as shown in FIG. 2.

In FIG. 3, an OS (operating system) is installed in the computer and communicates with a wide range of hardware modules through drivers A, B, and C. On the other hand, the OS communicates with application programs A, B, and C through API (application-programming interface). By using this sort of software architecture, the computer 104 as shown in FIG. 1 can complete the designated tasks in order.

In the embodiment, the external video adaptor 108 may have been already supported by the OS and a user has no need to install a corresponding driver—expending extra effort—in the computer 104. It should be appreciated that, in an alternative embodiment, in a situation in which the OS does not support the external video adaptor 108, it may need a corresponding driver to be installed by the user, such that the OS can know how to communicate with the external video adaptor 108.

For example, with usage of an interface provided by the OS, the external display 102 may be configured to display the same content as that shown on the built-in display 106, or the user may interact with the interface to configure the external display 102 to display different content from that shown on the built-in display 106 to display more information. It is also possible to configure it such that the external display 102 is dedicated to display the output of a particular application program, such as video-stream playback.

The driver may provide messages to the OS for further judgment and process. However, the driver may handle part of the communications with the external video adaptor 108 and has no need to pass all messages to the OS depending on different design requirements.

In the detailed examples to be described below, a portion of the process of the external adaptor 108, as being required, may be handled by the corresponding driver.

The source code of the driver may be provided by the manufacturer of the external video adaptor 108 with an optical disk, downloaded from a particular web location by users, or delivered via other media. The driver source code may be written and distributed by a third party.

In the embodiment, the software, in the conceptual perspective, is separated by multiple modules in multiple layers. The above separation is not exhaustive, and it should be understood that those who are skilled in the art may modify the above-mentioned software architecture to fulfill particular requirements. Alternatively, all or part of the modules illustrated therein can be implemented by IC hardware components.

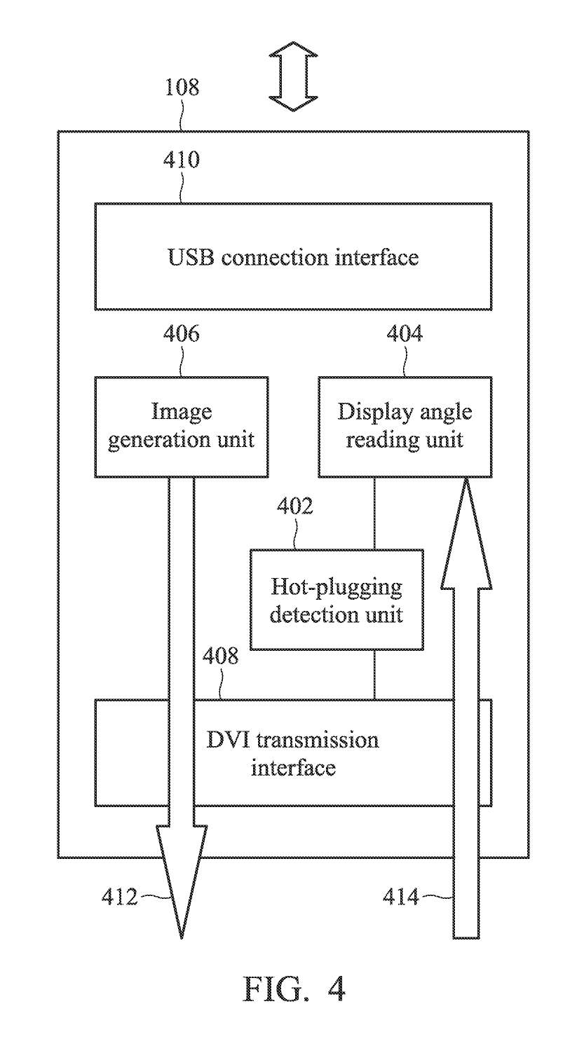

Please refer to FIG. 4, which illustrates the exemplary hardware configurations of the external adaptor 108 as shown in FIG. 1.

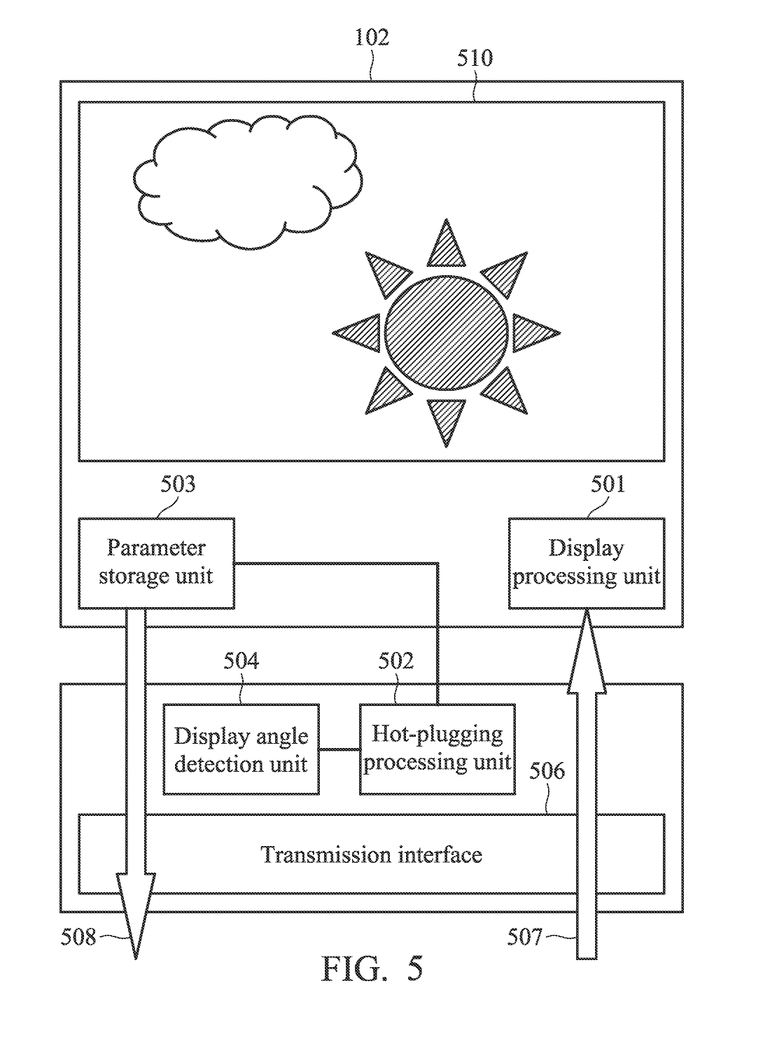

The exemplary external adaptor 108 comprises a hot-plugging detection unit 402, a display angle reading unit 404, an image generation unit 406, a DVI transmission interface 408, and a USB connection interface 410. The external video adaptor 108 cooperates with the computer 104 to provide an image stream 412 to the aforementioned external display 102. The external video adaptor 108 reads out display parameters 414 from the external display 102. The display parameters 414 comprise information regarding the profile of the image stream 412 to be provided, thereby causing the external display 102 to know the details of the image stream 412. The following, with reference to FIG. 5, will describe how the external video adaptor 108 cooperates with the external display 102 to complete the designated tasks.

Please refer to FIG. 5, which illustrates exemplary implementations of the external display 102 as shown in FIG. 1.

The exemplary external display 102 comprises a display processing unit 501, a hot-plugging processing unit 502, a parameter storage unit 503, a display angle detection unit 504, a transmission interface 506, and a display panel 510. The display processing unit 501 generates corresponding display images according the image stream 507 from the transmission interface 506. The parameter storage unit 503 stores the display parameters of the external display 102 as well, comprising relevant information to be transmitted to the external video adaptor 108. The display detection unit 504 and the hot-plugging processing unit 502 are configured to contributively modify an image orientation.

While the parameter storage unit 503, the display processing unit 501, the display panel 510, the display angle detection unit 504, the hot-plugging processing unit 502, and the transmission interface 506 are included in the external display 102 as its entirety as being described herein, it should be apparent that the above-mentioned modules may be practiced in multiple enclosures. For example, the hot-plugging processing unit 502, etc. may be installed in a set-top box, which is incorporated with a television having a display panel, to form the exemplary external display 102.

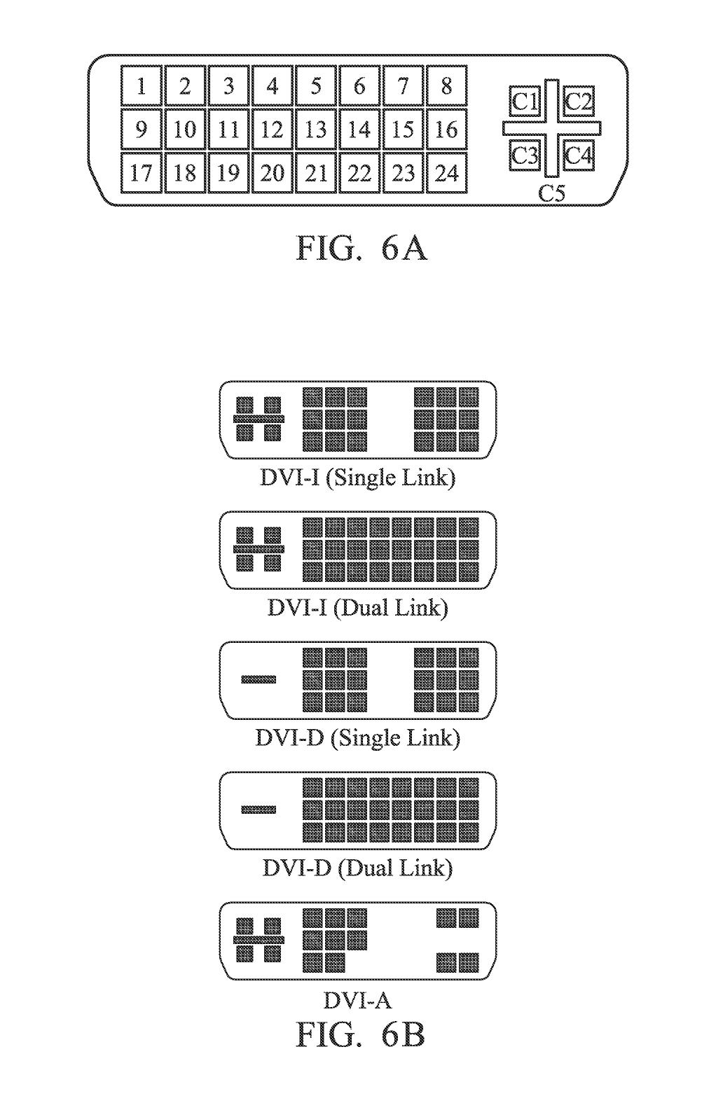

Next, please refer to FIGS. 6A and 6B, illustrating a schematic diagram of DVI transmission interface pins.

The DVI specification defines several sub-categories, such as DVI-I, DVI-D and DVI-A, etc. as shown in FIG. 6B. Detailed specification of the pins and transmission interface are well-known in the art, and omitted here for brevity.

It should be noted that the pin labeled 16 as shown in FIG. 6A is utilized to detect the hot-plugging status in light of the DVI specification. By reading the electrical signal of pin 16, an electronic device can know if there is any display compatible with the DVI specification that is connected to a corresponding controller through the DVI transmission interface.

In other words, even when an electronic device is operating, a display still can connect to the electronic device instantly via the DVI transmission interface without restarting. The electronic device, by reading the electrical signal of pin 16, such as a voltage level, knows when it should start the initiation to the display and when it should start providing the image data thereto.

In addition to the comprehension of the hot-plugging status through pin 16, the DVI specification defines EDID (extended display identification data) to carry information regarding the manufacturer's name, serial number, etc.

Since the above information is stored in the storage unit of a display, the electronic device follows the defined protocol to read out the EDID from the display when discovering that a new DVI display is connecting to the electronic device. The electronic device then determines which format and type of data should be provided to the connected DVI display.

With the hot-plugging mechanism, different types of DVI displays can connect to the electronic device without a further reset. The electronic device reads out the EDID and accordingly determines how to communicate once detecting that a DVI display is connecting, so as to avoid wrong configuration.

While the DVI is described in the example, it should be apparent that the disclosed implementations can be incorporated in, or integrated with, any specification that is capable of hot-plugging and providing display-related parameters to the plugged electronic device. Thus, the following concept may be adopted with relevant transmission protocols other than the DVI.

Transmission protocols can not only include wired but also wireless protocols, such as WiFi, Bluetooth, etc.

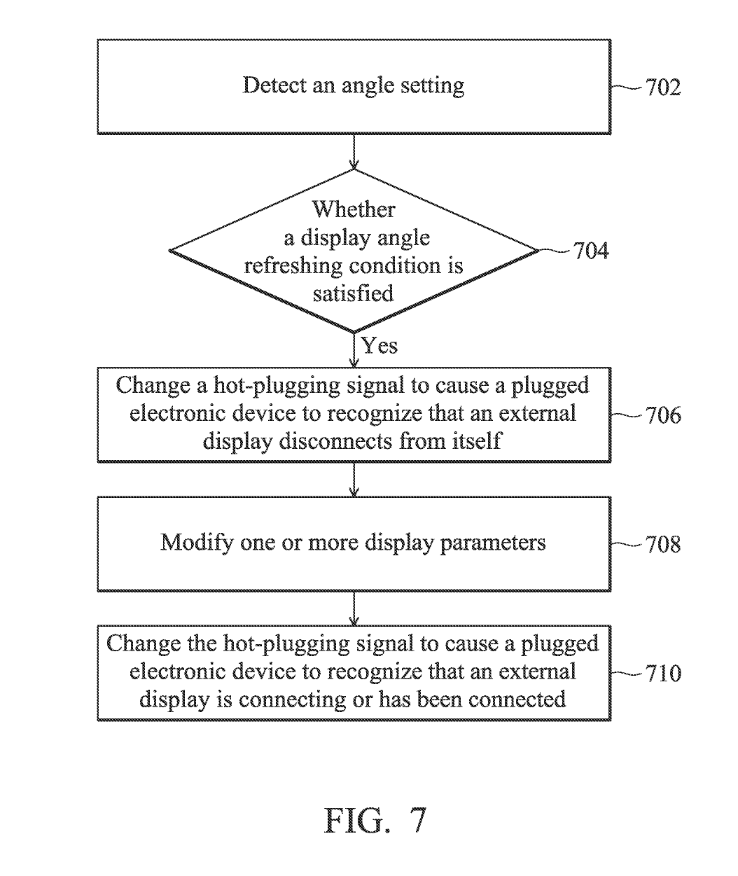

Please refer to FIG. 7 with reference to the mentioned FIGS. 1 to 6B. FIG. 7 illustrates how to flexibly modify display images by the usage of the hot-plugging mechanism and the display parameters of EDID and the like.

Following the above description, the process begins with the display angle detection unit 504 to detect the display angle setting (step 702). For example, it is feasible to place a horizontal angle sensor, such as a G-sensor, in the external display 102. This sort of sensor provides information regarding the placement angle of the external display 102, for example, being rotated clockwise or counter-clockwise by 90°, 180°, 270° or 360°. The magnitude of the horizontal angle may be passed to the display angle detection unit 504 for reading.

Not only should the electronic-type horizontal angle sensor be apparent to those skilled in the art, but also a wide range of mechanical-type or electromagnetic-type horizontal angle sensors, or others capable of continuously sensing the horizontal placement of an external display, may be utilized. Since a sensor capable of continuous sensing is used, for fulfilling some design requirements, the horizontal angle sensor may be paused, or the horizontal angle detection unit 504 may modify the magnitudes output from the horizontal angle sensor. For example, although the external display is placed in a normal position, that is, the longer edge thereof is substantially parallel to ground, the displayed image is intentionally clockwise or counter-clockwise, rotated by 90° regardless of the normal placement. Those skilled in art may refer the normal position as under the landscape mode. Or, although the display is clockwise rotated by 90° by the user, causing the longer edge of the external display to be substantially vertical to the ground, the displayed image is rotated counter-clockwise by 90° to maintain the displayed image's original orientation in human perception, regardless of the rotation. Those skilled in art may refer the rotated position as being in portrait mode.

Furthermore, input devices such as buttons or keyboards, with menu items of OSD (on screen display), can be manipulated by users to provide messages to the display angle detection unit 504. Through manual control, users may rotate the displayed images even when the external display is not physically rotated. Any combination of the aforementioned input devices and OSD may be collectively referred to as a manual angle setting unit to allow the user to configure the image orientation manually.

Next, it is determined whether a display angle refreshing condition is satisfied (step 704). The step may be performed by the hot-plugging processing unit 502 of FIG. 5 as an example. The display angle refreshing condition may vary with different design considerations. For example, the display angle refreshing condition is satisfied when detecting that the external display has been rotated clockwise or counter-clockwise by more than 45°. In another example, not only should the magnitude of the rotation be fulfilled, the display angle refreshing condition also requires that the rotated position be maintained over a predefined time period, such as 5 seconds. The display angle refreshing condition is determined to be satisfied after detecting the two sub-conditions.

After it is determined that the display angle refreshing condition has been satisfied, the hot-plugging processing unit 502 changes the hot-plugging signal to cause a plugged electronic device to recognize that the external display disconnects (step 706), in other words, it disconnects from the display processing unit 501. For example, it can be achieved by changing the electrical signal of DVI pin 16, such as a voltage level. Although the external display 102 is still physically connected to the video adaptor 108, the video adaptor 108 recognizes that the external display 102 is disconnected after detecting the signal change of DVI pin 16.

Subsequently, the hot-plugging processing unit 502 modifies one or more display parameters (step 708). The modification is used to maintain consistency to the current display placement. Those who are skilled in the art will appreciate that many ways can be used to perform the modification. For example, a reserved field defined by the DVI protocol may be utilized to indicate the current placement angle of the external display 102 or a rotation setting for displayed images. Two binary bits “00” indicate that the external display is not rotated or is rotated by 0°; “01” indicates a clockwise or counter-clockwise rotation by 90°; “10” indicates a clockwise or counter-clockwise rotation by 180°; and “11” indicates a clockwise or counter-clockwise rotation by 270°. Although the example has been described using rotation degrees that are multiples of 90°, it is noted that the invention is equally applicable to settings having other values, such as 37°, depending on different requirements, or to indicate similar but different meanings without departing from the spirit of the invention.

It should be appreciated that, in an alternative example of the invention, it may be achieved by changing the value of an existing field. In such cases, it may modify the EDID to cause the external video adaptor 108 to recognize that the plugged external display 102 has a 1024×768 resolution when the external display 102 is not rotated; and has a 768×1024 resolution when the external display 102 is clockwise or rotated counter-clockwise by 90°. Although it is the same external display, the external video adaptor 108 would recognize that the plugged external display has changed to a different display type when detecting a different EDID.

After modifying the display parameter(s), the hot-plugging processing unit 502 changes the hot-plugging signal again to cause a plugged electronic device to recognize that the external display is connecting or has been connected (step 710). Although the external display 102 does not disconnect from the external video adaptor 108 physically, the external video adaptor 108 recognizes the external display 12 as a newly hot-plugged display after detecting the hot-plugging signal change. Subsequently, the external video adaptor 108 reads out the EDID information of the external display 102, and decides which type of image stream to provide to the external display 102 accordingly.

For example, the external video adaptor 108 output an image stream of the 1024×768 resolution in response to the previously read EDID of a 1024×768 display. After reading out an EDID of a 768×1024 display, the external video adaptor 108 outputs an image stream of the 768×1024 resolution.

In the above case, the output images carried in the image stream are not rotated, but instead are changed at a different resolution, thus, the external display 102 (the display processing unit 501 in specific) needs to implement a corresponding rotation mechanism. It is to be understood that the above deployment yields a better performance because image-data computation by the external adaptor 108 and the computer 104 is typically faster than that by the external display 102, and the image source is typically stored in the computer 104 as well. The aforementioned scaling may be performed by any of various algorithms to modify (alternatively referred to as “resize”) the source images to fit into a designated resolution. Specifically, it may use well-known upsampling or interpolating algorithms to vertically or/and horizontally enlarge smaller imagery so that it fits into a bigger screen. Or, it may use well-known subsampling or downsampling algorithms to vertically or/and horizontally reduce larger imagery so that it fits into a smaller screen. Without changing the resolution, the external display 102 rotates the received images with light effort, for example, by using certain buffer space.

If a reserved field of EDID is in use, the external video adaptor 108 has to comprehend the meaning carried in the newly defined field. In other words, the video adaptor 108 performs corresponding rotations to the source images and provides to the external display 102 after obtaining information indicating that image rotation is required with a designated rotation angle for the external display 102.

It should be appreciated that, in an alternative deployment, all or a portion of the mentioned computations may be performed by the computer 104. For example, the relevant program code may be included in the driver. After loading and executing the driver, the processor 201 of the computer 104 transmits the computed results to the external video adaptor 108 and the external display 102 in sequence for display.

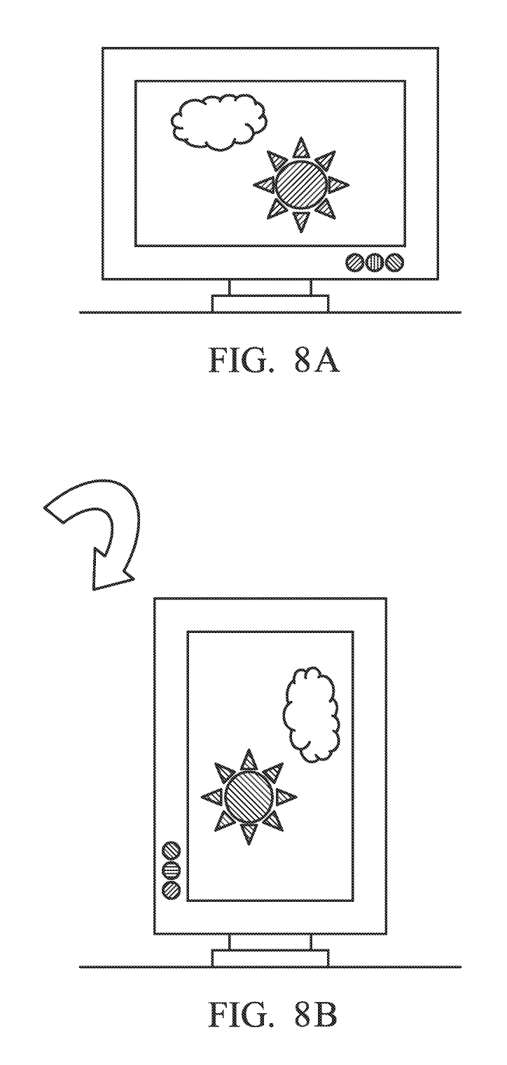

Please refer to FIGS. 8A to 8D. The four figures illustrate changes to a displayed image when the user rotates a display at different times according to an embodiment of the invention.

FIG. 8A illustrates an image displayed on a display yet to be rotated. Next, it can be seen in FIG. 8B that the display has been rotated clockwise by 90° and shows the image yet to be modified.

Then, according to the disclosed embodiment of the invention, the hot plugging processing unit 502 would change the hot-plugging signal, such as the voltage level of the DVI pin 16. At this moment, the external display 102 displays no image because the external video adaptor 108 determines that no display is being connected, and outputs no image stream. FIG. 8C illustrates a display temporarily displaying nothing.

After one or more display parameters are modified, the hot-plugging processing unit 502 changes the hot-plugging signal again to cause the external video adaptor 108 to recognize that a display is connecting. After reading out the modified EDID information, the external video adaptor 108 knows that display images carried in an image stream need to be rotated counter-clockwise by 90°, and accordingly rotates the source images. FIG. 8D illustrates the external display displaying the modified images in a manner that is consistent with the rotated position of the external display.

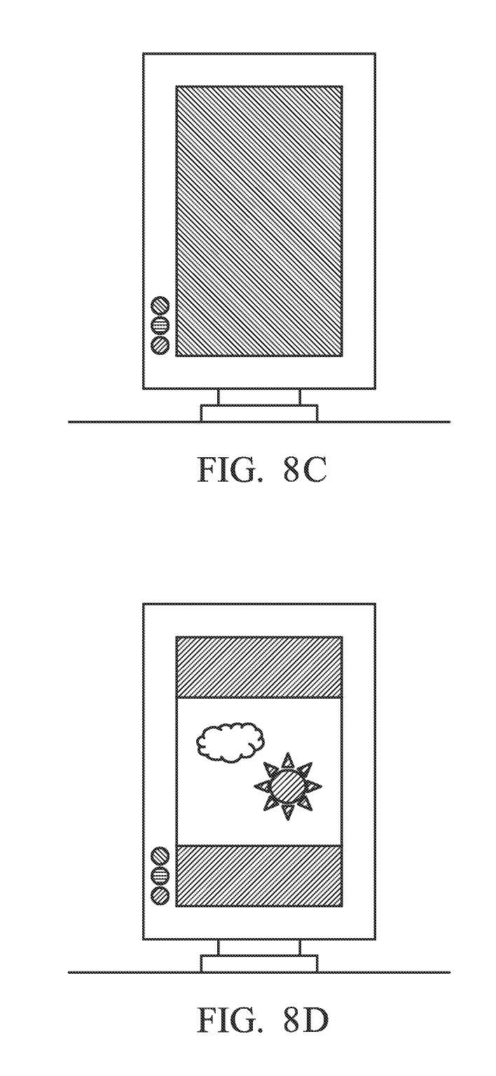

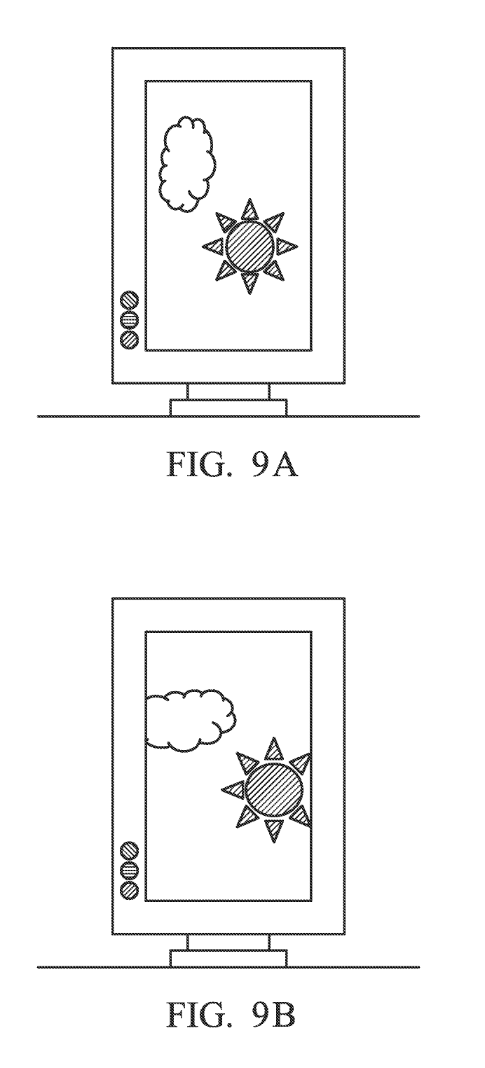

The rotation may need to perform a cutting or reshaping operation to the source images in some cases because most displays have different length and width. The computation may be performed by the external adaptor 108 alone, or the whole process may be divided into two parts, one being performed by the external adaptor 108 and the other being performed by the computer 102, where the exact division varies with different design considerations. FIG. 9A illustrates a rotated image undergoing reshaping while FIG. 9B illustrates a rotated image undergoing cutting.

While the external adaptor 108 is responsible for dealing with the hot-plugging for the external display 102 and performing image rotation as being described herein, it should be apparent that the video adaptor 108 may be practiced to combine into the computer 104, or the like.

Moreover, the aforementioned hot-plugging processing unit 502 or other associated components may be implemented in different ways. For example, it could be implemented in simple electric circuits, or by putting the corresponding circuit logics together with the display processing unit 501 of the external display 501. The hot-plugging processing unit 502 or other associated components may be implemented using hardware, software or a combination thereof depending on design requirements.

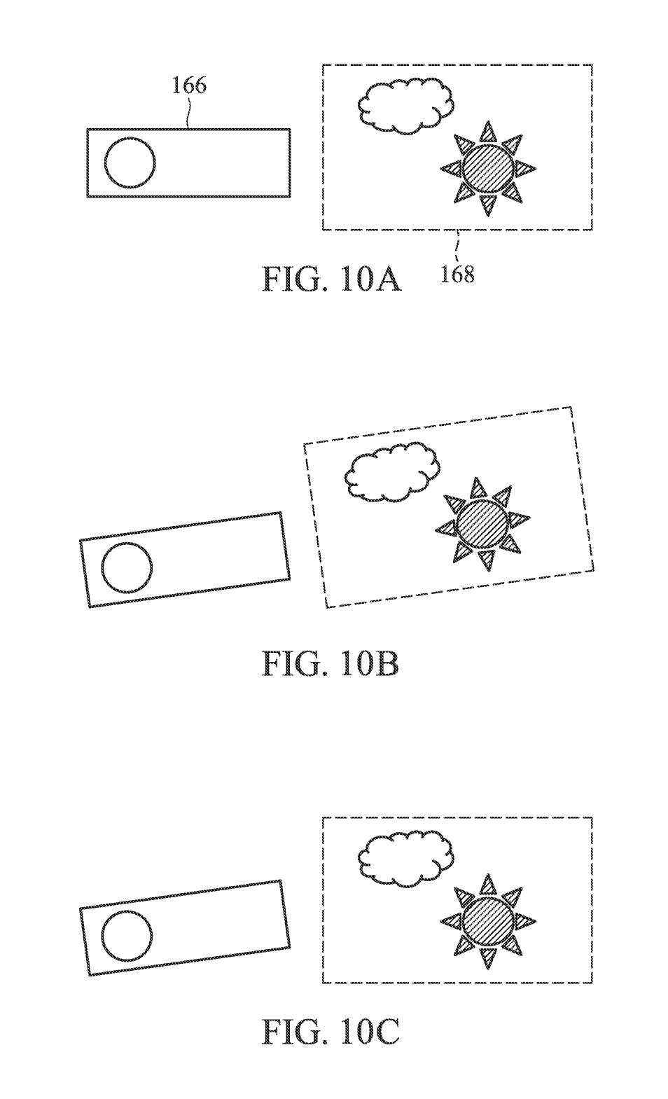

FIGS. 10A to 10C illustrate an embodiment applied to a projector 166. FIG. 10A illustrates the projector 166 projecting a regular image 168 when being placed stably in a normal position. FIG. 10B illustrates a skewed image 168 when the projector 166 is placed askew. Conventionally, the projection settings of the projector 166 may need to be altered to perform a skew compensation. According to the embodiment of the invention, after detecting that it has been placed askew, the projector 166 changes the hot-plugging signal, modifies EDID values and changes the hot-plugging signal again. Therefore, a computer (not shown) connecting to the projector 166 performs the corresponding skew compensation and outputs the compensated images to the projector 166.

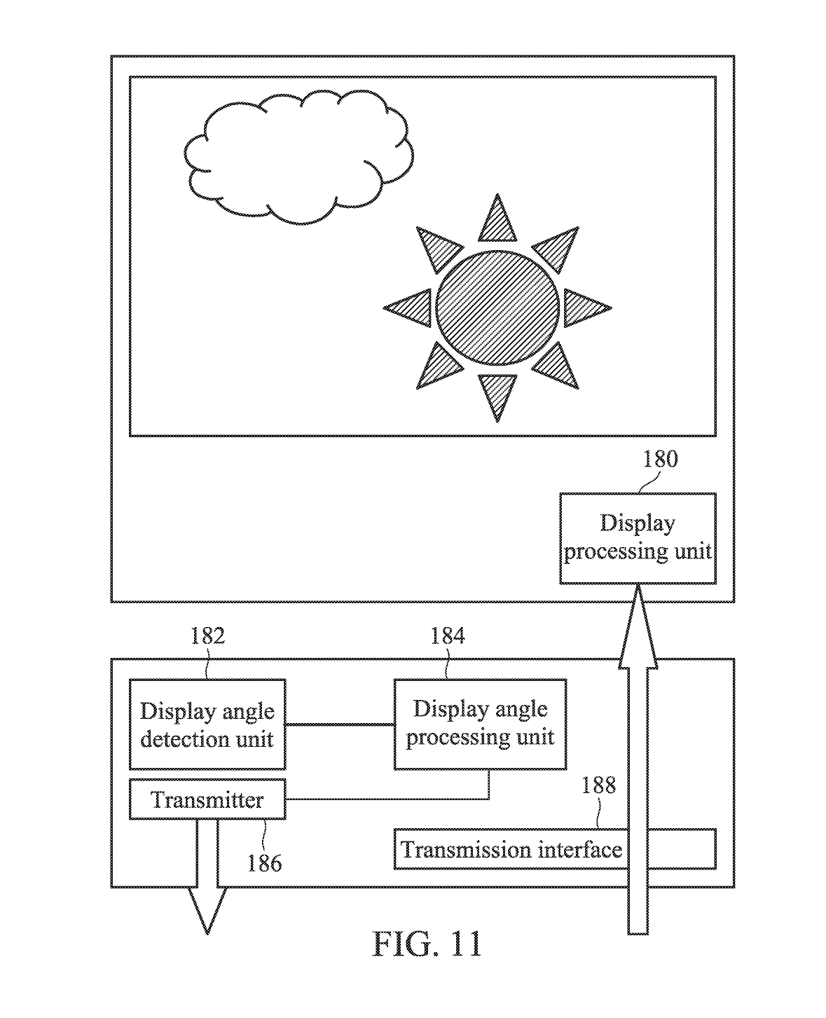

FIG. 11 illustrates another exemplary implementation of the external display. The external display comprises a display processing unit 180, a display angle detection unit 182, a display angle processing unit 184, a transmitter 186 and a transmission interface 188.

Herein, the placement angle of the external display detected by the display angle detection unit 182 does not output through the transmission interface 188 the same as being utilized in image stream transmission, such as DVI, but through the transmitter 186 using another transmission interface, such as I2C. By doing so, there is no need to implement the hot-plugging mechanism.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for contributively modifying an image orientation of a display image generated by a display processing unit, wherein said display processing unit receives an image stream from an external apparatus through a transmission interface and accordingly generates said display image, comprising:
a display angle detection unit configured to detect a display angle setting; and
a hot-plugging processing unit configured to connect to said display angle detection unit and a parameter storage unit, wherein said parameter storage unit stores a display parameter being utilized to determine how to modify images, and said external apparatus reads out said display parameter and provides said image stream corresponding to said display parameter,
wherein, said hot-plugging processing unit changes a hot-plugging signal to cause said external apparatus to recognize that said display processing unit disconnects therefrom when said display angle setting satisfies a display angle refreshing condition;
said hot-plugging processing unit modifies content of said display parameter with a new display parameter value in consistent with current display placement; and
after said display parameter modification, said hot-plugging processing unit changes said hot-plugging signal to cause said external apparatus to recognize that a new apparatus is connecting, thereby enabling said external apparatus to read out said new display parameter value and generate said image stream corresponding to said new display parameter value.

2. The apparatus of claim 1, further comprising:
a display panel;
said display processing unit; and
said parameter storage unit,
wherein said display processing unit connects to said display panel, and said display panel displays said display image.

3. The apparatus of claim 1, further comprising:
a projection unit;
said display processing unit; and
said parameter storage unit,
wherein said display processing unit connects to said projection unit, and said projection unit projects said display image.

4. The apparatus of claim 1, wherein said hot-plugging signal is an electrical signal of a pin of said transmission interface.

5. The apparatus of claim 1, wherein said display parameter of said parameter storage is stored in a reserved field compatible with a video transmission interface standard.

6. The apparatus of claim 5, wherein said video transmission interface standard is DVI (digital visual interface) and said display parameter is EDID (extended display identification data) of DVI.

7. The apparatus of claim 1, wherein said display angle detection unit comprises a horizontal angle sensor configured to detect a placement angle thereof.

8. The apparatus of claim 1, wherein said display angle detection unit comprises a manual angle setting unit to facilitate a user to configure image orientation manually.

9. The apparatus of claim 8, wherein said manual angle setting unit comprises at least a button.

10. The apparatus of claim 9, wherein said manual angle setting unit displays a configuration prompt screen on display panel.

11. The apparatus of claim 1, wherein said display processing unit determines whether to perform a rotation operation to said image stream according to said new display parameter value.

12. The apparatus of claim 1, wherein said new display parameter value modified by said hot-plugging processing unit comprises a rotation angle parameter indicating a rotation degree.

13. The apparatus of claim 12, wherein said rotation degree is a multiple of 90°.

14. The apparatus of claim 1, wherein said new display parameter value modified by said hot-plugging processing unit comprises a scaling parameter indicating a scaling ratio of display image.

15. The apparatus of claim 1, wherein said transmission interface comprises a wireless transmission interface.

16. An apparatus for connecting to a display processing unit through a transmission interface and providing an image stream to said display processing unit, wherein said display processing unit generates a display image according to said image stream, comprising:
a hot-plugging detection unit configured to detect a hot-plugging signal to determine whether said display processing unit has connected thereto;
a display angle reading unit configured to connect to said hot-plugging detection unit and read out a display parameter from said display processing unit when detecting that said display processing unit has connected thereto, wherein said display parameter is a reserved field of a video transmission interface standard indicating an orientation of said display image; and
an image generation unit configured to connect to said display angle reading unit and generate said image stream according to said read-out display parameter.

17. The apparatus of claim 16, further comprising a connection interface configured to connect to an external apparatus, wherein the external apparatus outputs a source image stream corresponding to said image stream.

18. The apparatus of claim 17, wherein said connection interface is USB (universal serial bus) interface.

19. The apparatus of claim 16, wherein said hot-plugging signal is an electrical signal of a pin of said transmission interface.

20. The apparatus of claim 16, wherein said video transmission interface standard is DVI (digital visual interface) and said display parameter is EDID (extended display identification data) of DVI.

21. The apparatus of claim 16, wherein said display parameter comprises a rotation angle parameter indicating a rotation degree.

22. The apparatus of claim 16, wherein said display parameter comprises a scaling parameter indicating a scaling ratio of said display image.

23. An apparatus for contributively modifying an image orientation of a display image generated by a display processing unit, wherein a display processing unit receives an image stream from an external apparatus through a transmission interface and accordingly generates said display image, comprising:
a display angle detection unit configured to detect a display angle setting; and
a display angle processing unit configured to connect to said display angle detection unit to read out said display angle setting; and
a transmitter configured to connect to said display angle processing unit and transmit said display angle setting to said external apparatus,
wherein said external apparatus modifies said image stream when detecting that said display angle setting has been renewed, causing said display processing unit to be capable of displaying said display image corresponding to said renewed display angle setting.

24. The apparatus of claim 23, wherein said transmitter transmits said display angle setting to said external apparatus to said external apparatus through I2C transmission interface.
